(19) United States
(12) Patent Application Publication
(10) Pub. No.: US 2023/0228478 A1
(43) Pub. Date: Jul. 20, 2023

(54) REFRIGERATOR AND MANUFACTURING METHOD THEREOF

(71) Applicant: SAMSUNG ELECTRONICS CO., LTD., Suwon-si (KR)

(72) Inventors: Jinhyun PARK, Suwon-si (KR); Kookjeong SEO, Suwon-si (KR); Sungmin CHO, Suwon-si (KR)

(73) Assignee: SAMSUNG ELECTRONICS CO., LTD., Suwon-si (KR)

(21) Appl. No.: 18/123,163

(22) Filed: Mar. 17, 2023

Related U.S. Application Data
(63) Continuation of application No. PCT/KR2021/011500, filed on Aug. 27, 2021.

(30) Foreign Application Priority Data
Oct. 15, 2020 (KR) 10-2020-0133558

(51) Int. Cl. F25D 23/06

(52) U.S. Cl. CPC F25D 23/063; F25D 2201/14

(57) ABSTRACT

A main body of a refrigerating includes a plurality of vacuum insulation panels, each vacuum insulation panel of the plurality of vacuum insulation panels including an exterior material having first and second surfaces opposite to each other, and a core material in a vacuum state between the first and second surfaces of the exterior material. The plurality of vacuum insulation panels are assembled together so that the first surfaces of the exterior materials of the plurality of vacuum insulation panels form a storage compartment inside the main body.

### CROSS-REFERENCE TO RELATED APPLICATIONS

The present application is a continuation of International Application PCT/KR2021/011500, filed Aug. 27, 2021, and claims foreign priority to Korean Application 10-2020-0133558, filed Oct. 15, 2020, the disclosures of which are incorporated herein by reference in their entireties.

### BACKGROUND

### 1. Field

The present disclosure relates to a refrigerator and a manufacturing method thereof, and more particularly, to a refrigerator having an improved structure of a vacuum insulation panel and a manufacturing method thereof.

### 2. Description of Related Art

In general, a refrigerator is an apparatus including a main body having storage compartments and a cold air supply system for supplying cold air to the storage compartments to keep food fresh. The storage compartments include a refrigerating compartment that is maintained at temperature of about 0 degrees Celsius to 5 degrees Celsius to keep food refrigerated, and a freezing compartment that is maintained at temperature of about 0 degrees Celsius to −30 degrees Celsius to keep food frozen.

The front of the storage compartment is opened to allow food to be put in and out, and the opened front of the storage compartment is provided to be opened and closed by a door.

The main body includes an inner case forming the storage compartments, an outer case provided on the outside of the inner case to form an exterior, and an insulator disposed between the inner case and the outer case. When the main body is formed, the inner case and the outer case are pre-assembled, and then urethane is foamed and injected between the inner case and the outer case to form the insulator. In addition, there is a case in which a vacuum insulator is disposed together with urethane to improve insulation performance.

However, in this case, a large foaming facility is required for a urethane foaming process, and noise and odor may occur during foaming.

Therefore, recently, research on refrigerators excluding the urethane foaming process has been conducted, but in this case, it is very difficult to maintain the same insulation performance as when urethane is used. In addition, the rigidity and assembly quality of a refrigerator may not be secured only with the vacuum insulator.

### SUMMARY

According to an embodiment of the present disclosure, a refrigerator may include a main body including a plurality of vacuum insulation panels, each vacuum insulation panel of the plurality of vacuum insulation panels including an exterior material having first and second surfaces opposite to each other, and a core material in a vacuum state between the first and second surfaces of the exterior material, wherein the plurality of vacuum insulation panels are assembled together so that the first surfaces of the exterior materials of the plurality of vacuum insulation panels form a storage compartment inside the main body.

According to an embodiment of the present disclosure, the exterior material of each vacuum insulation panel of the plurality of vacuum insulation panels may include a first panel forming the first surface of the exterior material of the vacuum insulation panel, and a second panel coupled to the first panel and forming the second surface of the exterior material of the vacuum insulation panel.

According to an embodiment of the present disclosure, for each vacuum insulation panel of the plurality of vacuum insulation panels, both the first panel and the second panel of the vacuum insulation panel may include a plastic material having a thickness of 0.5 mm or more.

According to an embodiment of the present disclosure, for each vacuum insulation panel of the plurality of vacuum insulation panels, the first panel and the second panel of the vacuum insulation panel may be bonded with epoxy for vacuum.

According to an embodiment of the present disclosure, each vacuum insulation panel of the plurality of vacuum insulation panels may include a ring member disposed between the first panel and the second panel of the vacuum insulation panel to maintain the core material of the vacuum insulation panel in a vacuum state, and the second panel of each vacuum insulation panel of the plurality of vacuum insulation panels may include an accommodating groove formed to accommodate the ring member of the vacuum insulation panel.

According to an embodiment of the present disclosure, the first panels of the plurality of vacuum insulation panels may form an inner case of the main body.

According to an embodiment of the present disclosure, the second panel of each vacuum insulation panel of the plurality of vacuum insulation panels may include a metal material forming an outside surface of the second panel.

According to an embodiment of the present disclosure, the plastic material may include any one of ABS, PP, and PS.

According to an embodiment of the present disclosure, the core material may include glass fibers having a fiber diameter of 3 μm or more and 12 μm or less.

According to an embodiment of the present disclosure, the core material may include high-compression glass fibers having a restoring force of 50% or less.

According to an embodiment of the present disclosure, the core material may include glass fibers having a density of 100 kg/m³ or more.

According to an embodiment of the present disclosure, each vacuum insulation panel of the plurality of vacuum insulation panels may include an adsorbent provided to adsorb gas inside the core material of the vacuum insulation panel, and a vacuum valve mounted on the exterior material of the vacuum insulation panel.

According to an embodiment of the present disclosure, the plurality of vacuum insulation panels may form side walls, an upper wall, a lower wall, and a rear wall of the main body.

According to an embodiment of the present disclosure, each vacuum insulation panel of the plurality of vacuum insulation panels may include a blocking layer formed inside the exterior material of the vacuum insulation panel to block gas permeation through the exterior material of the vacuum insulation material.

According to an embodiment of the present disclosure, the first surface of the exterior material of each vacuum insulation panel of the plurality of vacuum insulation panels may include a plastic material having a thickness of 0.5 mm or more, and the second surface of each vacuum insulation panel of the plurality of vacuum insulation panels may include a metal material.

Another embodiment of the present disclosure, a refrigerator includes a main body, and a storage compartment provided inside the main body, wherein the main body includes a plurality of vacuum insulation panels, wherein each of the plurality of vacuum insulation panels includes a core material provided in a vacuum state, and an exterior material provided to accommodate the core material and to be sealed, and wherein a first surface of the exterior material is exposed to the storage compartment, and a second surface of the exterior material opposite to the first surface is exposed to the outside.

According to an embodiment of the present disclosure, the exterior material may include a first panel forming the first surface and a second panel forming the second surface.

According to an embodiment of the present disclosure, the core material may include high-density glass fibers having a density of 100 kg/m³ or more and disposed between the first panel and the second panel to support the first panel and the second panel.

According to an embodiment of the present disclosure, a manufacturing method of a refrigerator includes disposing a core material including glass fibers on a first panel, inserting an adsorbent into the core material, bonding a second panel including a vacuum valve to the first panel, forming a plurality of vacuum insulation panels by forming the core material provided between the first panel and the second panel to be in a vacuum state through the vacuum valve, and assembling the plurality of vacuum insulation panels.

According to an embodiment of the present disclosure, the manufacturing method of the refrigerator may include bonding the first panel and the second panel with epoxy.

Additional aspects will be set forth in part in the description which follows and, in part, will be apparent from the description, or may be learned by practice of the presented embodiments.

### BRIEF DESCRIPTION OF THE DRAWINGS

Aspects, features, and advantages of certain embodiments of the present disclosure will be more apparent from the following description taken in conjunction with the accompanying drawings, in which:

FIG. 1 is a perspective view illustrating an exterior of a refrigerator according to an embodiment of the present disclosure.

FIG. 2 is a perspective view illustrating a state in which a plurality of vacuum insulation panels of the refrigerator according to an embodiment of the present disclosure is coupled to each other.

FIG. 3 is an exploded perspective view of the vacuum insulation panel of the refrigerator according to an embodiment of the present disclosure.

FIG. 4 is a coupled cross-sectional view of the vacuum insulation panel in FIG. 3.

FIG. 5 is an exploded perspective view of a vacuum insulation panel of a refrigerator according to another embodiment of the present disclosure.

FIG. 6 is a coupled cross-sectional view of the vacuum insulation panel in FIG. 5.

FIG. 7 is a bottom perspective view of a second panel illustrated in FIG. 5.

FIG. 8 is an exploded perspective view of a vacuum insulation panel of a refrigerator according to another embodiment of the present disclosure.

FIG. 9 is a flowchart illustrating a method of manufacturing a refrigerator according to an embodiment of the present disclosure.

### DETAILED DESCRIPTION

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used herein are for the purpose of describing the embodiments and are not intended to restrict and/or to limit the present disclosure. For example, the singular expressions herein may include plural expressions, unless the context clearly dictates otherwise. Also, the terms “comprises” and “has” are intended to indicate that there are features, numbers, steps, operations, elements, parts, or combinations thereof described in the specification, and do not exclude the presence or addition of one or more other features, numbers, steps, operations, elements, parts, or combinations thereof.

It will be understood that, although the terms first, second, etc. may be used herein to describe various components, these components should not be limited by these terms, and these terms are only used to distinguish one component from another. For example, without departing from the scope of the present disclosure, the first component may be referred to as a second component, and similarly, the second component may also be referred to as a first component. The term “and/or” includes any combination of a plurality of related items or any one of a plurality of related items.

In this specification, the terms “front end,” “rear end,” “upper portion,” “lower portion,” “upper end” and “lower end” used in the following description are defined with reference to the drawings, and the shape and position of each component are not limited by these terms.

Various embodiments of the present disclosure are directed to providing a refrigerator capable of forming a storage compartment only with a vacuum insulation panel itself by improving a structure of the vacuum insulation panel, and a manufacturing method thereof.

Moreover, various embodiments of the present disclosure are directed to providing a refrigerator capable of securing insulation performance while improving the rigidity and assembly quality of a vacuum insulation panel, and a manufacturing method thereof.

According to various embodiments of the present disclosure, by providing a refrigerator in which a urethane foaming process is excluded and a plurality of vacuum insulation panels is assembled, only a part of the refrigerator can be partially replaced and productivity of the refrigerator can be improved.

Further, according to various embodiments of the present disclosure, by providing a refrigerator in which the plurality of vacuum insulation panels themselves form a storage compartment, manufacturing processes and parts of the refrigerator can be simplified.

In addition, according to various embodiments of the present disclosure, required insulation performance of a refrigerator can be secured while a structure of the plurality of vacuum insulation panels is improved to have rigidity.

Hereinafter, embodiments of the present disclosure will be described in detail with reference to the accompanying drawings.

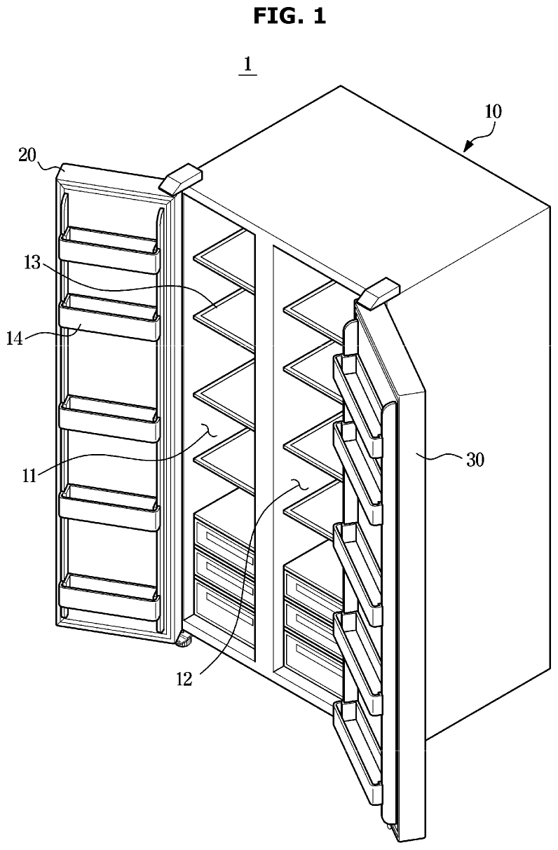

FIG. 1 is a perspective view illustrating an exterior of a refrigerator according to an embodiment of the present disclosure.

Referring to FIG. 1, a refrigerator 1 may include a main body 10 forming an exterior and storage compartments 11 and 12 provided inside the main body 10 such that the fronts thereof are opened.

The main body 10 may be provided to have a box shape in which one side is opened. The storage compartments 11 and 12 may be formed inside the main body 10.

The storage compartments 11 and 12 may include the refrigerating compartment 11 and the freezing compartment 12. The front sides of the storage compartments 11 and 12 may be opened such that food may be put in and out. The storage compartments 11 and 12 may be partitioned left and right by a partition wall, and the refrigerating compartment 11 may be provided on one side thereof and the freezing compartment 12 may be provided on the other side thereof. The refrigerator 1 according to an embodiment of the present disclosure is described as an example of the side-by-side refrigerator 1, but a shape of the refrigerator 1 may not be limited thereto.

The refrigerator 1 may include doors 20 and 30 provided to open and close the storage compartments 11 and 12. The doors 20 and 30 may include the freezing compartment door 20 and the refrigerating compartment door 30.

The refrigerating compartment 11 and the freezing compartment 12 may be opened and closed by the refrigerating compartment door 30 and the freezing compartment door 20, which are rotatably coupled to the main body 10, respectively. In addition, a plurality of door guards 14 may be provided on rear surfaces of the refrigerating compartment door 30 and the freezing compartment door 20 to accommodate food and the like.

A plurality of shelves 13 are provided in the storage compartments 11 and 12 to partition the inside of the storage compartments 11 and 12 into a plurality of spaces. Various items such as food may be placed on the shelf 13. In addition, storage boxes (not shown) may be provided in the storage compartments 11 and 12 to be drawn in and out in a sliding manner.

The refrigerator 1 may include a cooling system provided to supply cold air to the storage compartments 11 and 12.

The cooling system may include a compressor, a condenser, an expansion valve, an evaporator, and a blowing fan. This cooling system may be disposed in a machine room provided at a lower rear side of the main body 10.

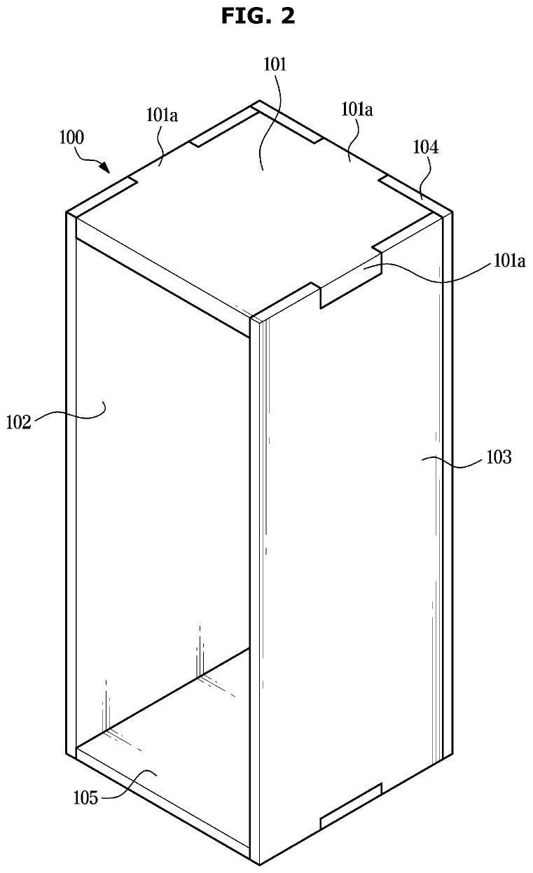

FIG. 2 is a perspective view illustrating a state in which a plurality of vacuum insulation panels of the refrigerator 1 according to an embodiment of the present disclosure is coupled to each other.

Referring to FIG. 2, the refrigerator 1 may include a plurality of vacuum insulation panels 100.

The plurality of vacuum insulation panels 100 may include a first vacuum insulation panel 101, a second vacuum insulation panel 102, a third vacuum insulation panel 103, a fourth vacuum insulation panel 104, and a fifth vacuum insulation panel 105.

The plurality of vacuum insulation panels 100 may be formed in a structure capable of being assembled with each other. For example, the plurality of vacuum insulation panels 100 may be assembled in a manner of being fitted and inserted into each other by being formed as male and female pairs. Alternatively, the plurality of vacuum insulation panels 100 may be assembled by being bonded by an adhesive material such as hot melt.

The first vacuum insulation panel 101 may include coupling parts 101a. A part of the second to fourth vacuum insulation panels 102, 103, and 104 that are coupled to the first vacuum insulation panel 101 may be provided in a groove shape to correspond to each of the coupling parts 101a.

However, a coupling method between the plurality of vacuum insulation panels 100 may not be limited thereto. FIG. 2 illustrates that the coupling parts 101a of the first vacuum insulation panel 101 protrude, but the shape of the coupling parts 101a may also not be limited thereto. It is sufficient as long as the coupling part 101a of the vacuum insulation panel 101 is provided such that each of the plurality of vacuum insulation panels 100 may be assembled.

The plurality of vacuum insulation panels 100 may be provided to be coupled to each other to form side walls, an upper wall, a lower wall, and a rear wall of the main body 10. More specifically, the first vacuum insulation panel 101 may be provided to form the upper wall of the main body 10. The second vacuum insulation panel 102 and the third vacuum insulation panel 103 may be provided to form both the sidewalls of the main body 10. The fourth vacuum insulation panel 104 may be provided to form the rear wall of the main body 10. The fifth vacuum insulation panel 105 may be provided to form the lower wall of the main body 10.

When the plurality of vacuum insulation panels 100 is coupled, a heat bridge may occur at fastening portions. Accordingly, moisture may be generated on the plurality of vacuum insulation panels 100 to form dew.

In order to prevent this, separate heat bridge prevention members (not shown) may be coupled to the fastening portions of the plurality of vacuum insulation panels 100. The heat bridge prevention member (not shown) may be made of a low thermal conductivity plastic (thermal breaker) having a thermal conductivity of 70 mW/m*K or less. The heat bridge prevention member (not shown) may be provided in a substantially L-shape and coupled to a connection portion between the plurality of vacuum insulation panels 100.

Each of the vacuum insulation panels 100 may be coupled to each other to form the storage compartments 11 and 12. Specifically, the storage compartments 11 and 12 may be formed inside the plurality of vacuum insulation panels 100.

In addition, an aesthetic exterior of the refrigerator 1 may be improved by exterior panels coupled to the outside of the plurality of vacuum insulation panels 100 and exposed to the outside. A detailed description of this will be given later.

Because the plurality of vacuum insulation panels 100 is made of the same structure, description of the vacuum insulation panel 100 will be described later taking the first vacuum insulation panel 101 as an example. In addition, the first vacuum insulation panel 101 will be named and described later as a vacuum insulation panel.

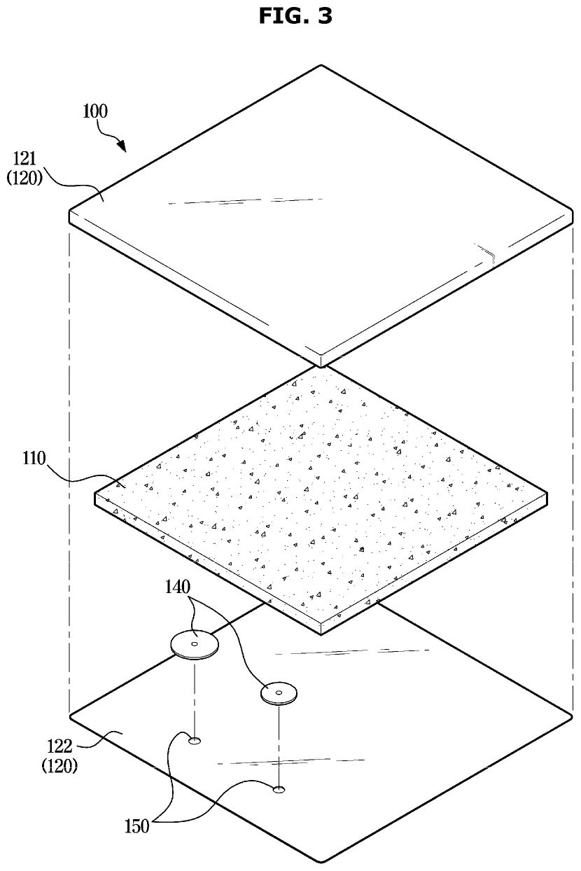

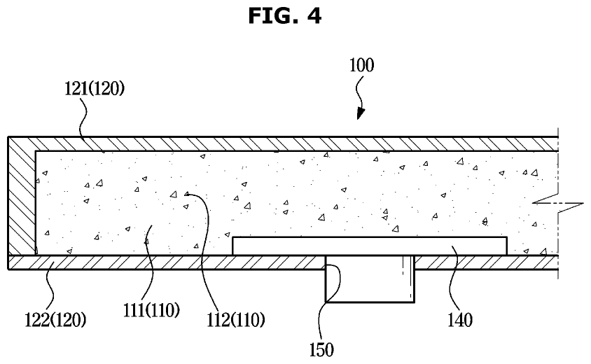

FIG. 3 is an exploded perspective view of the vacuum insulation panel of the refrigerator 1 according to an embodiment of the present disclosure. FIG. 4 is a coupled cross-sectional view of the vacuum insulation panel in FIG. 3.

Referring to FIGS. 3 and 4, the vacuum insulation panel 100 may include an exterior material 120 and a core material 110.

The exterior material 120 may be provided to accommodate the core material 110. The exterior material 120 serves to maintain a lifespan of the vacuum insulation panel 100 by blocking fine gas and moisture penetrating into the core material 110 being in a vacuum state.

One surface of the exterior material 120 of the refrigerator 1 according to an embodiment of the present disclosure may be exposed to the storage compartments 11 and 12. That is, the exterior material 120 may be provided to form the storage compartments 11 and 12.

The exterior material 120 may include a first panel 122 and a second panel 121.

The first panel 122 of the exterior material 120 may be provided to form one surface of the exterior material 120. The second panel 121 of the exterior material 120 may be provided to form the other surface opposite to the one surface of the exterior material 120. That is, the first panel 122 may be provided to form the storage compartments 11 and 12, and the second panel 121 may be disposed at the outside of the storage compartments 11 and 12 to be opposite thereto. In other words, the first panel 122 may be provided to form the inner case of the main body 10.

The first panel 122 and the second panel 121 may be coupled to each other. The core material 110 may be accommodated inside the second panel 121. The first panel 122 may be provided to cover the core material 110 and the second panel 121.

However, the shapes of the first panel 122 and the second panel 121 may not be limited thereto. For example, an accommodating space for accommodating the core material 110 may be formed in both the first panel 122 and the second panel 121. That is, the arrangement of the core material 110 is not limited, and any design change may be possible as long as the first panel 122 and the second panel 121 are coupled to accommodate the core material 110 in a sealed state.

Both the first panel 122 and the second panel 121 may include a plastic material having a thickness of 0.5 mm or more. The plastic material may include a material such as ABS, PP, and PS.

In a conventional vacuum insulator, the exterior material 120 is formed of a material such as a non-rigid film and disposed between the inner case and the outer case of the main body 10. The exterior materials 120 of the conventional vacuum insulator are bonded to each other by fusion or adhesion to maintain the inside thereof in a vacuum state.

However, as one side of the exterior material 120 of the vacuum insulation panel 100 of the present disclosure is exposed to the storage compartments 11 and 12 to form the storage compartments 11 and 12, because a member such as the shelf 13 needs to be mounted thereon, as described above, the exterior material needs to be provided with a certain thickness or more to ensure rigidity.

Therefore, when the exterior materials 120 having such a material and thickness are bonded to each other, an adhesion method for maintaining an internal vacuum state is required. A description of this will be given below.

The first panel 122 and the second panel 121 of the exterior material 120 may be bonded with epoxy for vacuum.

The first panel 122 and the second panel 121 may be bonded to each other by applying epoxy for vacuum to adhesive surfaces where the first panel 122 and the second panel 121 come into contact with each other.

In addition, a contact area of the adhesive surfaces may be widened by forming irregularities on the adhesive surfaces where the first panel 122 and the second panel 121 come into contact with each other. Through this, a contact force between the first panel 122 and the second panel 121 may be further strengthened.

However, the coupling method of the first panel 122 and the second panel 121 is not limited thereto. The first panel 122 and the second panel 121 may be coupled to each other by various methods as long as airtightness is ensured so that the core material 110 inside the first panel 122 and the second panel 121 may maintain the vacuum state.

The first panel 122 may include a vacuum hole 150. A vacuum valve 140, which will be described later, may be coupled to the vacuum hole 150 of the first panel 122.

A blocking layer may be formed inside the exterior material 120 to block gas permeation. More specifically, the blocking layer may be formed on an inner surface of the exterior material 120. The blocking layer may be formed on inner surfaces of the first panel 122 and the second panel 121.

The blocking layer of the exterior material 120 may be provided to have a thickness of 0.3 μm or more. The blocking layer may be formed by depositing aluminum or inorganic oxide. The blocking layer may be composed of an inorganic oxide thin film layer or a polymer resin. The inorganic oxide may be formed by physical vapor deposition (evaporating sputtering or aerosol deposition), chemical vapor deposition (plating or CVD), or wet coating of aluminum oxide, silicon oxide, titanium oxide, or the like.

By forming such a blocking layer, a porous hole or the like that may be included in the exterior material 120 may be blocked so that the vacuum state of the vacuum insulation panel 100 may be maintained.

The core material 110 may be provided in the vacuum state inside the vacuum insulation panel 100. Specifically, the core material 110 may be accommodated between the first panel 122 and the second panel 121.

The core material 110 may include a sheet member 111 and an adsorbent (getter) 112.

The sheet member 111 may be made of a material that minimizes a change in volume before and after vacuum.

The sheet member 111 may include glass fibers. The glass fibers may have a fiber diameter of 3 μm or more and 12 μm or less. The glass fibers may have a restoring force of 10% or less. The glass fibers may have a density of 200 kg/m³ or more.

A core material used in a conventional vacuum insulator is provided to have a large change in volume before and after vacuum. As the core material shrinks in a vacuum process, an outer cover material accommodating the core material may be bent or cracks may occur on the outer cover material.

However, as described above, when the core material 110 according to the present disclosure is manufactured using high-density and high-compression glass fibers that minimize a change in volume before and after vacuum, a structural stability may be guaranteed. In addition, the glass fibers themselves having these characteristics serve to support the first panel 122 and the second panel 121, so that the vacuum insulation panel 100 in which shape deformation before and after vacuum is minimized may be formed without a separate support member disposed therein.

Through this, the refrigerator 1 may be weight lightening and at the same time, the rigidity of the vacuum insulation panel 100 may also be secured.

The core material 110 may be made of other inorganic materials in addition to the glass fibers described above. When the core material 110 is formed of an organic material, it may be difficult to maintain a vacuum as gas and the like is continuously discharged, and accordingly, it may be difficult to maintain the insulation performance of the vacuum insulation panel 100.

For example, the core material 110 may be made of fumed silica or expanded vermiculite. However, it is efficient in terms of price and weight to use the above-described glass fibers.

The adsorbent 112 may be provided to adsorb moisture and gas inside the vacuum insulation panel 100. The adsorbent 112 may be provided to be inserted into the sheet member 111. Through this, the vacuum state inside the vacuum insulation panel 100 may be maintained for a long period of time.

When moisture is to be absorbed through the adsorbent 112, a porous material such as quicklime (CaO) and zeolite may be mainly used. As the adsorbent 112 according to the present disclosure, the adsorbent 112 of various metal components for adsorbing gases such as nitrogen and oxygen may be used. As the adsorbent 112 of these metal components, a mixture mainly based on zirconium (Zr), titanium (Ti), aluminum (Al), vanadium (V), iron (Fe), silver (Ag), etc. may be provided. However, depending on a purpose, the mixture may be provided by mixing other metals in addition to the above-mentioned metals.

The vacuum insulation panel 100 may include the vacuum valve 140. The vacuum valve 140 may be mounted on the exterior material 120. More specifically, the vacuum valve 140 may be coupled to the vacuum hole 150 formed on the first panel 122. Through this, the inside of the vacuum insulation panel 100 may be formed in the vacuum state through pressure reduction using the vacuum valve 140 after the first panel 122 and the second panel 121 are bonded. In this case, a degree of vacuum inside the vacuum insulation panel 100 may be provided to 4 Torr or less. More appropriately, the degree of vacuum inside the vacuum insulation panel 100 may be provided to 100 mTorr or less.

According to the above description of the present disclosure, the first panel 122 is exposed to the storage compartments 11 and 12 to form the storage compartments 11 and 12, and the second panel 121 is disposed outside the storage compartments 11 and 12. However, the arrangement of the first panel 122 and the second panel 121 may not be limited thereto. For example, the second panel 121 may be exposed to the storage compartments 11 and 12 to form the storage compartments 11 and 12. Accordingly, the first panel 122 may be arranged outside the storage chambers 11 and 12, and the exterior panel may be provided to be coupled thereto.

As described above, because the vacuum insulation panel 100 itself of the refrigerator 1 according to an embodiment of the present disclosure serves as an inner case, the main body 10 may not include a member for forming a separate inner case.

In addition, the ease of assembly may be improved by directly coupling a separate exterior panel exposed to the outside to form the exterior of the refrigerator 1 to the vacuum insulation panel 100 described above.

Through this, the refrigerator 1 may be weight lightening and productivity may be improved. In addition, the storage capacity of the storage compartments 11 and 12 may be further increased.

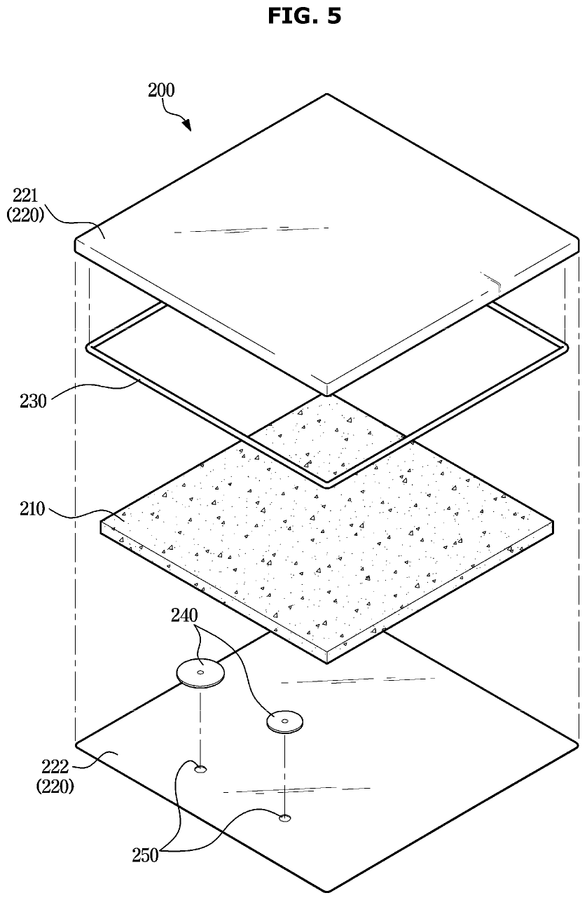

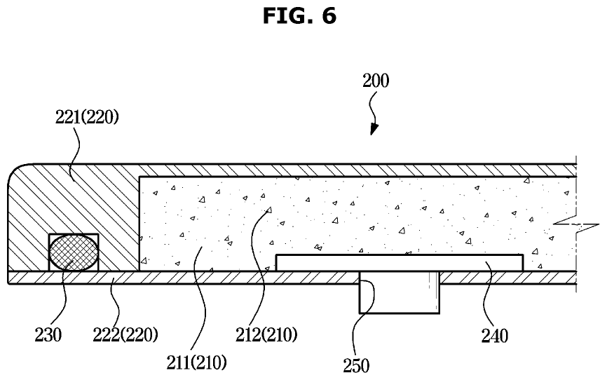

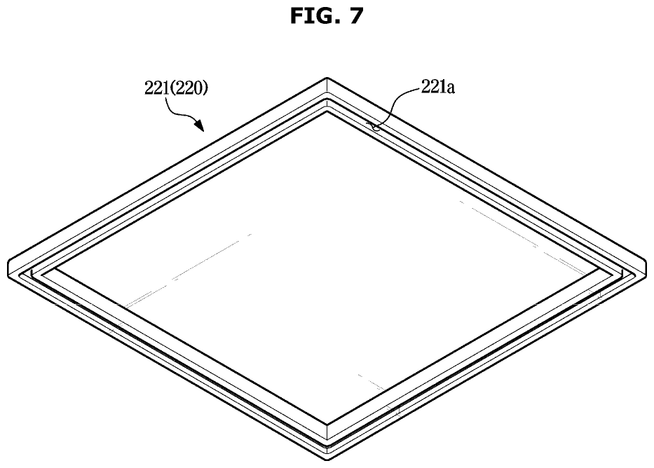

FIG. 5 is an exploded perspective view of a vacuum insulation panel of a refrigerator according to another embodiment of the present disclosure. FIG. 6 is a coupled cross-sectional view of the vacuum insulation panel in FIG. 5. FIG. 7 is a bottom perspective view of a second panel illustrated in FIG. 5.

Referring FIGS. 5 and 6, a vacuum insulation panel 200 may include an exterior material 220 and a core material 210. Unlike the vacuum insulation panel 100 of the refrigerator according to an embodiment of the present disclosure, the vacuum insulation panel 200 of a refrigerator according to another embodiment of the present disclosure may also include a ring member 230.

The exterior material 220 may be provided to accommodate the core material 210. The exterior material 220 serves to maintain a lifespan of the vacuum insulation panel 200 by blocking fine gas and moisture penetrating into the core material 210 being in a vacuum state.

One surface of the exterior material 220 of the refrigerator according to another embodiment of the present disclosure may be exposed to a storage compartment. That is, the exterior material 220 may be provided to form the storage compartment.

The exterior material 220 may include a first panel 222 and a second panel 221.

The first panel 222 of the exterior material 220 may be provided to form one surface of the exterior material 220. The second panel 221 of the exterior material 220 may be provided to form the other surface opposite to the one surface of the exterior material 220. That is, the first panel 222 may be provided to form the storage compartment, and the second panel 221 may be disposed at the outside of the storage compartment to be opposite thereto. In other words, the first panel 222 may be provided to form an inner case of a main body.

The first panel 222 and the second panel 221 may be coupled to each other. The core material 210 may be accommodated inside the second panel 221. The first panel 222 may be provided to cover the core material 210 and the second panel 221.

However, the shapes of the first panel 222 and the second panel 221 may not be limited thereto. For example, an accommodating space for accommodating the core material 210 may be formed in both the first panel 222 and the second panel 221. That is, the arrangement of the core material 210 is not limited, and any design change may be possible as long as the first panel 222 and the second panel 221 are coupled to accommodate the core material 210 in a sealed state.

Both the first panel 222 and the second panel 221 may include a plastic material having a thickness of 0.5 mm or more. The plastic material may include a material such as ABS, PP, and PS.

The first panel 222 may include a vacuum hole 250. A vacuum valve 240, which will be described later, may be coupled to the vacuum hole 250 of the first panel 222.

The vacuum insulation panel 200 may include the vacuum valve 240. The vacuum valve 240 may be mounted on the exterior material 220. More specifically, the vacuum valve 240 may be coupled to the vacuum hole 250 formed on the first panel 222. Through this, the inside of the vacuum insulation panel 200 may be formed in the vacuum state through pressure reduction using the vacuum valve 240 after the first panel 222 and the second panel 221 are bonded. In this case, a degree of vacuum inside the vacuum insulation panel 200 may be provided to 4 Torr or less. More appropriately, the degree of vacuum inside the vacuum insulation panel 200 may be provided to 100 mTorr or less.

In a conventional vacuum insulator, an exterior material is formed of a material such as a non-rigid film and disposed between an inner case and an outer case of a main body. The exterior materials of the conventional vacuum insulator are bonded to each other by fusion or adhesion to maintain the inside in a vacuum state.

However, as one side of the exterior material 220 of the vacuum insulation panel 200 of the present disclosure is exposed to the storage compartment to form the storage compartment, because a member such as a shelf needs to be mounted thereon, as described above, the exterior material needs to be provided with a certain thickness or more to ensure rigidity.

Therefore, when the exterior materials 220 having such a material and thickness are bonded to each other, an adhesion method for maintaining an internal vacuum state is required. A description of this will be given later.

A blocking layer may be formed inside the exterior material 220 to block gas permeation. More specifically, the blocking layer may be formed on an inner surface of the exterior material 220. The blocking layer may be formed on inner surfaces of the first panel 222 and the second panel 221.

The blocking layer of the exterior material 220 may be provided to have a thickness of 0.3 μm or more. The blocking layer may be formed by depositing aluminum or inorganic oxide. The blocking layer may be composed of an inorganic oxide thin film layer or a polymer resin. The inorganic oxide may be formed by physical vapor deposition (evaporating sputtering or aerosol deposition), chemical vapor deposition (plating or CVD), or wet coating of aluminum oxide, silicon oxide, titanium oxide, or the like.

The core material 210 may be provided in the vacuum state inside the vacuum insulation panel 200. Specifically, the core material 210 may be accommodated between the first panel 222 and the second panel 221.

The core material 210 may include a sheet member 211 and an adsorbent (getter) 212.

The sheet member 211 may be made of a material that minimizes a change in volume before and after vacuum.

The sheet member 211 may include glass fibers. The glass fibers may have a fiber diameter of 3 μm or more and 12 μm or less. The glass fibers may have a restoring force of 50% or less. The glass fibers may have a density of 100 kg/m³ or more.

The core material 210 used in a conventional vacuum insulator is provided to have a large change in volume before and after vacuum. As such the core material 210 shrinks in a vacuum process, an outer cover material accommodating the core material 210 may be bent or cracks may occur on the outer cover material.

However, as described above, when the core material 210 according to the present disclosure is manufactured using high-density and high-compression glass fibers that minimize a change in volume before and after vacuum, a structural stability may be guaranteed. In addition, the glass fibers themselves having these characteristics serves to support the first panel 222 and the second panel 221, so that the vacuum insulation panel 200 in which shape deformation before and after vacuum is minimized may be formed without a separate support member disposed therein.

Through this, the refrigerator may be weight lightening and at the same time, the rigidity of the vacuum insulation panel 200 may also be secured.

The core material 210 may be made of other inorganic materials in addition to the glass fibers described above. When the core material 210 is formed of an organic material, it may be difficult to maintain a vacuum as gas and the like is continuously discharged, and accordingly, it may be difficult to maintain the insulation performance of the vacuum insulation panel 200.

For example, the core material 210 may be made of fumed silica or expanded vermiculite. However, it is efficient in terms of price and weight to use the above-described glass fibers.

The adsorbent 212 may be provided to adsorb moisture and gas inside the vacuum insulation panel 200. The adsorbent 212 may be provided to be inserted into the sheet member 211. Through this, the vacuum state inside the vacuum insulation panel 200 may be maintained for a long period of time.

When moisture is to be absorbed through the adsorbent 212, a porous material such as quicklime (CaO) and zeolite may be mainly used. As the adsorbent 212 according to the present disclosure, the adsorbent 212 of various metal components for adsorbing gases such as nitrogen and oxygen may be used. As the adsorbent 212 of these metal components, a mixture mainly based on zirconium (Zr), titanium (Ti), aluminum (Al), vanadium (V), iron (Fe), silver (Ag), etc. may be provided. However, depending on a purpose, the mixture may be provided by mixing other metals in addition to the above-mentioned metals.

Unlike the vacuum insulation panel 100 of the refrigerator according to an embodiment of the present disclosure, in the vacuum insulation panel 200 of the refrigerator according to another embodiment of the present disclosure, the first panel 222 and the second panel 221, which form the exterior material 220, may not be bonded by using only a separate adhesive material (epoxy, etc.).

The vacuum insulation panel 200 of the refrigerator according to another embodiment of the present disclosure may include a ring member 230. The ring member 230 may be provided in a ring shape closed along an edge of the second panel 221. The ring member 230 may be made of a material having elasticity. Therefore, the ring member 230 may be provided to be compressed as the inside of the vacuum insulation panel 200 is depressurized.

As illustrated in FIGS. 6 and 7, the second panel 221 may include an accommodating groove 221a provided to accommodate the ring member 230.

The ring member 230 may be disposed in the accommodating groove 221a of the second panel 221. In this case, an adhesive such as epoxy may be used to fix the ring member 230.

After the ring member 230 is disposed on the second panel 221, the first panel 222 is disposed on one side of the second panel 221 so that the core material 210 therein is not exposed. Thereafter, the inside of the first panel 222 and the second panel 221 may be depressurized through the vacuum valve 240 and the vacuum hole 250 so that the core material 210 may be in the vacuum state. In this case, due to a pressure difference between the inside and outside of the vacuum insulation panel 200, the first panel 222 and the second panel 221 may be coupled to each other to maintain airtightness. That is, the first panel 222 and the second panel 221 may be in a state of being adsorbed to each other.

Therefore, in the case of the vacuum insulation panel 100 of the refrigerator according to an embodiment of the present disclosure, epoxy needs time to be cured, and a separate crimping jig for compressing the first panel 222 and the second panel 221 needs to be used while curing is in progress.

However, because the vacuum insulation panel 200 of the refrigerator according to another embodiment of the present disclosure may reduce an amount of epoxy to be used, the epoxy curing time may be greatly reduced. Therefore, because the more vacuum insulation panels 200 may be produced compared to the same time, productivity may be improved.

FIG. 6 illustrates that the ring member 230 is disposed in the accommodating groove 221a formed on the second panel 221, but the arrangement of the ring member 230 and the formation position of the accommodating groove 221a may not be limited thereto. For example, the ring member 230 may be formed to be simultaneously accommodated in the first panel 222 and the second panel 221.

In addition, according to the description of the present disclosure, the first panel 222 is provided to be exposed to the storage compartment to form the storage compartment, and the second panel 221 is disposed outside the storage compartment.

However, as mentioned in the description of the refrigerator 1 according to an embodiment of the present disclosure, the arrangement of the first panel 222 and the second panel 221 may not be limited thereto. For example, the second panel 221 may be exposed to the storage compartment to form the storage compartment. Accordingly, the first panel 222 may be provided to be disposed outside the storage compartment and the exterior panel may be provided to be coupled thereto.

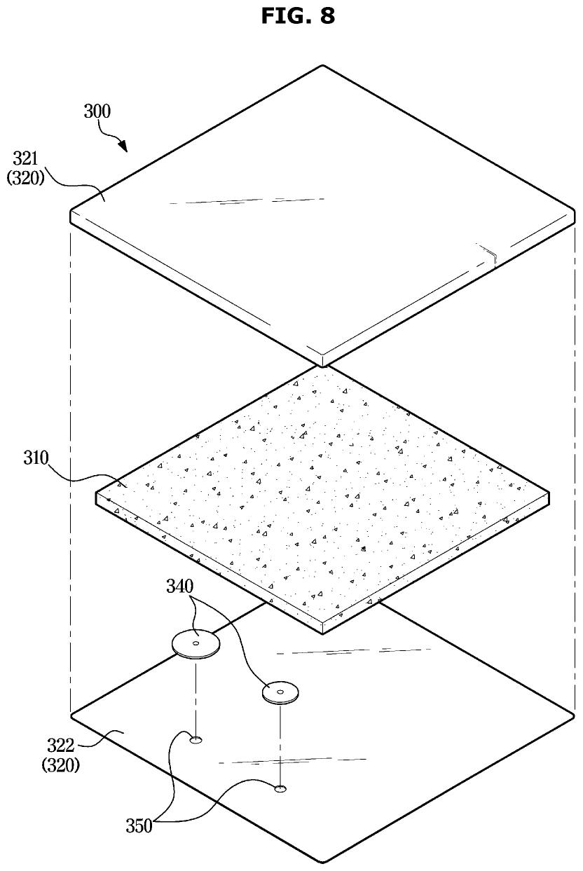

FIG. 8 is an exploded perspective view of a vacuum insulation panel of a refrigerator according to another embodiment of the present disclosure.

Referring to FIG. 8, a vacuum insulation panel 300 of a refrigerator according to another embodiment of the present disclosure may include a first panel 322, a second panel 321, a core material 310, and a vacuum valve 340.

The core material 310 of the vacuum insulation panel 300 of a refrigerator according to another embodiment of the present disclosure may be provided identically to the above-described vacuum insulation panel 100 of the refrigerator according to one embodiment of the present disclosure. The vacuum hole 350 and the vacuum valve 340 formed on the first panel 322 are also the same as above. Hereinafter, structures different from the vacuum insulation panel 100 of the refrigerator according to an embodiment of the present disclosure will be mainly described.

Unlike the vacuum insulation panel 100 of the refrigerator according to an embodiment of the present disclosure, the vacuum insulation panel 300 of the refrigerator according to another embodiment of the present disclosure may be provided such that the first panel 322 is exposed to a storage compartment and the second panel 321 is exposed to the outside.

More specifically, the first panel 322 may be provided to form a first surface of an exterior material 320, and the second panel 321 may be provided to form a second surface of the exterior material 320 opposite to the first surface.

Therefore, the first surface of the exterior material 320 may be exposed to the storage compartment, and the second surface of the exterior material 320 may be exposed to the outside.

The first panel 322 exposed to the storage compartment may include a plastic material having a thickness of 0.5 mm or more. The plastic material may include a material such as ABS, PP, and PS.

The second panel 321 exposed to the outside may include a metal material. The second panel 321 may form as an exterior panel that forms an exterior of the refrigerator and may be recognized from the outside by a user. Therefore, the second panel 321 itself may be used to improve an aesthetic exterior of the refrigerator.

That is, unlike the vacuum insulation panel 300 of the refrigerator according to one embodiment and another embodiment of the present disclosure, the vacuum insulation panel 300 of the refrigerator according to another embodiment of the present disclosure may be provided to serve as both the inner case and the outer case of the main body. Through this, manufacturing processes may be greatly simplified and the structure of the refrigerator may be configured simply.

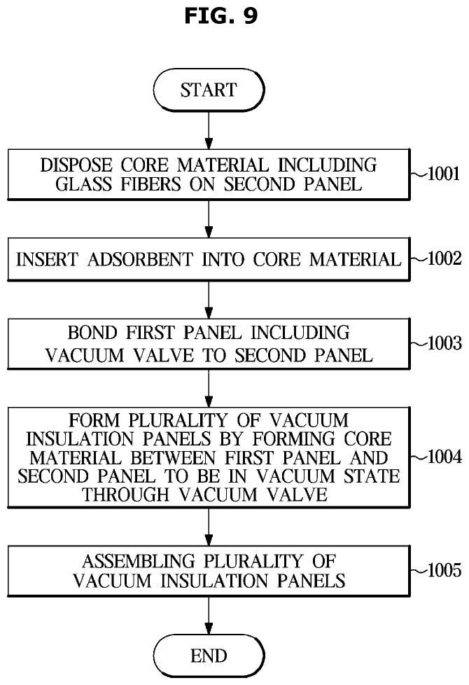

FIG. 9 is a flowchart illustrating a method of manufacturing a refrigerator according to an embodiment of the present disclosure.

Referring to FIG. 9, first, the core material 110 including glass fibers is disposed on the second panel 121 (1001).

The core material 110 may include the sheet member 111 including high-density and high-compression glass fibers.

Thereafter, the adsorbent 112 is inserted into the core material 110 (1002).

In this case, the core material 110 may be the sheet member 111 such as glass fibers. The adsorbent 112 is disposed to adsorb gas or the like that may be generated inside the vacuum insulation panel 100.

Thereafter, the first panel 122 including the vacuum valve 140 is bonded to the second panel 121 (1003).

As the vacuum hole 150 is formed on the first panel 122, the vacuum valve 140 may be mounted on the first panel 122. The method of bonding the first panel 122 and the second panel 121 may be coupling through epoxy for vacuum as described above, or may be bonded by adsorption by including the ring member.

Thereafter, the core material 110 between the first panel 122 and the second panel 121 may be made to be in a vacuum state through the vacuum valve 140 to form the vacuum insulation panel 100 (1004).

In this case, a plurality of the vacuum insulation panels 100 may be provided.

The refrigerator 1 may be formed by assembling the plurality of vacuum insulation panels 100 formed as described above (1005).

More specifically, the inner case of the refrigerator 1 may be formed as the plurality of vacuum insulation panels 100 is assembled. Alternatively, both the inner case and the outer case of the refrigerator 1 may be formed as the plurality of vacuum insulation panels 100 are assembled.

When the inner case of the refrigerator 1 is formed with the plurality of vacuum insulation panels 100, the first panel 122 and the second panel 121 may include a plastic material having a thickness of 0.5 mm or more to have rigidity.

In addition, when both the inner case and the outer case of the refrigerator 1 are formed with a plurality of vacuum insulation panels 100, a panel forming the inner case among the first panel 122 and the second panel 121 may include a plastic material having a thickness of 0.5 mm or more, and a panel forming the outer case may include a metal material.

Although the technical spirit of the present disclosure has been described by specific embodiments, the scope of the present disclosure is not limited to these embodiments. Various embodiments that may be modified or modified by those skilled in the art of the present disclosure would also be within the scope of the present disclosure, without departing from the gist of the present disclosure specified in the claims.

What is claimed is:

1. A refrigerator comprising:
a storage compartment;
a main body forming the storage compartment inside the main body and including a plurality of vacuum insulation panels, each vacuum insulation panel of the plurality of vacuum insulation panels including:
an exterior material having first and second surfaces opposite to each other, and
a core material in a vacuum state between the first and second surfaces of the exterior material,
wherein the plurality of vacuum insulation panels are assembled together so that the first surfaces of the exterior materials of the plurality of vacuum insulation panels form the storage compartment.

2. The refrigerator according to claim 1, wherein the exterior material of each vacuum insulation panel of the plurality of vacuum insulation panels includes a first panel forming the first surface of the exterior material of the vacuum insulation panel, and a second panel coupled to the first panel and forming the second surface of the exterior material of the vacuum insulation panel.

3. The refrigerator according to claim 2, wherein, for each vacuum insulation panel of the plurality of vacuum insulation panels, both the first panel and the second panel of the vacuum insulation panel include a plastic material having a thickness of 0.5 mm or more.

4. The refrigerator according to claim 3, wherein, for each vacuum insulation panel of the plurality of vacuum insulation panels, the first panel and the second panel of the vacuum insulation panel are bonded with epoxy for vacuum.

5. The refrigerator according to claim 3, wherein
each vacuum insulation panel of the plurality of vacuum insulation panels incudes a ring member disposed between the first panel and the second panel of the vacuum insulation panel to maintain the core material of the vacuum insulation panel in a vacuum state, and
the second panel of each vacuum insulation panel of the plurality of vacuum insulation panels includes an accommodating groove formed to accommodate the ring member of the vacuum insulation panel.

6. The refrigerator according to claim 2, wherein
the first panel of the plurality of vacuum insulation panels form an inner case of the main body.

7. The refrigerator according to claim 6, wherein
the second panel of each vacuum insulation panel of the plurality of vacuum insulation panels includes a metal material forming an outside surface of the second panel.

8. The refrigerator according to claim 3, wherein the plastic material includes any one of ABS, PP, and PS.

9. The refrigerator according to claim 1, wherein the core material includes glass fibers having a fiber diameter of 3 μm or more and 12 μm or less.

10. The refrigerator according to claim 1, wherein the core material includes high-compression glass fibers having a restoring force of 50% or less.

11. The refrigerator according to claim 1, wherein the core material includes glass fibers having a density of 100 kg/m³ or more.

12. The refrigerator according to claim 1, wherein each vacuum insulation panel of the plurality of vacuum insulation panels includes an adsorbent provided to adsorb gas inside the core material of the vacuum insulation panel, and a vacuum valve mounted on the exterior material of the vacuum insulation panel.

13. The refrigerator according to claim 1, wherein the plurality of vacuum insulation panels form side walls, an upper wall, a lower wall, and a rear wall of the main body.

14. The refrigerator according to claim 1, wherein each vacuum insulation panel of the plurality of vacuum insulation panels includes a blocking layer formed inside the exterior material of the vacuum insulation panel to block gas permeation through the exterior material of the vacuum insulation material.

15. The refrigerator according to claim 1, wherein the first surface of the exterior material of each vacuum insulation panel of the plurality of vacuum insulation panels includes a plastic material having a thickness of 0.5 mm or more, and the second surface of each vacuum insulation panel of the plurality of vacuum insulation panels includes a metal material.
